(19) United States
(12) Patent Application Publication
(10) Pub. No.: US 2021/0302672 A1
(43) Pub. Date: Sep. 30, 2021

(54) OPTICAL RECEPTACLE AND OPTICAL MODULE

(71) Applicant: Enplas Corporation, Saitama (JP)

(72) Inventors: Yuki SAITO, Saitama (JP); Ayano KON, Saitama (JP)

(21) Appl. No.: 17/213,276

(22) Filed: Mar. 26, 2021

(30) Foreign Application Priority Data
Mar. 27, 2020 (JP) 2020-057415

(51) Int. Cl. G02B 6/42

(52) U.S. Cl. CPC G02B 6/4214

(57) ABSTRACT

An optical receptacle includes a first incidence surface, a first emission surface, and a reflection transmission part. The reflection transmission part includes an individual reflection surface, an individual transmission surface, and an individual connection surface. 0°<θa<37°, 70°<θb≤90° and θa+θb≥100° are satisfied where θa represents an angle between the individual transmission surface and an installation surface of the optical receptacle to a substrate and θb represents an angle between the individual connection surface and the installation surface.

### CROSS REFERENCE TO RELATED APPLICATIONS

This application is entitled to the benefit of Japanese Patent Application No. 2020-057415, filed on Mar. 27, 2020, the disclosure of which including the specification, drawings and abstract is incorporated herein by reference in its entirety.

### TECHNICAL FIELD

The present invention relates to an optical receptacle and an optical module.

### BACKGROUND ART

In the related art, an optical module including a light-emitting element such as a surface-emitting laser (such as a vertical cavity surface emitting laser (VCSEL)) is used in optical communications using optical transmission members such as optical fibers and light waveguides. An optical module includes one or more photoelectric conversion elements (light-emitting elements or light reception elements), and an optical receptacle for transmission, for reception or for transmission and reception.

In an optical module for optical communications, a part of light emitted from the light-emitting element is in some cases used as detection light to detect whether light is appropriately emitted from the light-emitting element (see, for example, PTL 1). In addition, in an optical module for transmission, the quantity of light emitted from the optical receptacle is in some cases required to be attenuated from the viewpoint of safety measures.

The optical receptacle (light coupling member) disclosed in PTL 1 includes a first lens part serving as an incidence surface, a second lens part serving as an emission surface, and a reflection part disposed on an optical path between the first lens part and the second lens part. In the reflection part, a transmission part including a connection surface and a transmission surface for transmitting light entered from the first lens part is disposed. The optical receptacle is integrally molded as a single piece using a resin material, for example.

In the optical receptacle disclosed in PTL 1, light emitted from light-emitting element is entered from the first lens part. Next, a part of the light entered from the first lens part is reflected at the reflection part toward the second lens part. The light reflected by the reflection part is emitted at the second lens part toward the end portion of the optical transmission member. On the other hand, another part of the light entered from the first lens part is transmitted through the light transmission surface. The light transmitted through the transmission surface reaches a detection element disposed opposite the light-emitting element. In this manner, in the optical receptacle disclosed in PTL 1, a part of the light emitted from the light-emitting element is used as transmission light travelling toward the optical transmission member, and another part of the light is used as detection light travelling toward the detection element.

### CITATION LIST

### Patent Literature

### PTL 1

### Japanese Patent Application Laid-Open No. 2012-163903

### SUMMARY OF INVENTION

### Technical Problem

As described above, the optical receptacle disclosed in PTL 1 is integrally molded as a single piece using a resin material. As such, in the optical receptacle disclosed in PTL 1, the melted resin cannot appropriately enter the portion corresponding to the boundary portion between the transmission surface and the connection surface in the metal mold cavity, and consequently the shape of the metal mold may not be transferred as intended. In this case, the boundary portion between the transmission surface and the connection surface may be formed in an unintended shape, and a part of the light entered from the incidence surface may be reflected to an unintended direction at the boundary portion between the light transmission surface and the connection surface as stray light travelling toward light-emitting element side.

In view of this, an object of the present invention is to provide an optical receptacle that can attenuate light emitted from the light-emitting element while reducing generation of stray light travelling toward the light-emitting element side. In addition, another object of the present invention is to provide an optical module including the optical receptacle.

### Solution to Problem

An optical receptacle of an embodiment of the present invention includes is configured to optically couple a light-emitting element disposed on a substrate and an optical transmission member in a state where the optical receptacle is disposed between the light-emitting element and the optical transmission member, the optical receptacle including a first incidence surface configured to allow incidence of light emitted from the light-emitting element; a first emission surface configured to emit, toward the optical transmission member, light entered from the first incidence surface and advanced inside the optical receptacle; and a reflection transmission part configured to reflect, toward the first emission surface, a part of the light entered from the first incidence surface, and transmit another part of the light entered from the first incidence surface. The reflection transmission part includes an individual reflection surface configured to reflect, toward the first emission surface, the part of the light entered from the first incidence surface, an individual transmission surface configured to transmit the other part of the light entered from the first incidence surface, and an individual connection surface configured to connect the individual reflection surface and the individual transmission surface.

The following Equation (1) to Equation (3) are satisfied:

0°<θa<37° Equation (1)

70°<θb≤90° Equation (2)

θa+θb≥100° Equation (3)

where θa is an angle between the individual transmission surface and an installation surface of the optical receptacle to the substrate, and θb is an angle between the individual connection surface and the installation surface.

In addition, an optical module of an embodiment of the present invention includes a photoelectric conversion device including a light-emitting element; and the optical receptacle according to claim 1 configured to optically couple light emitted from the light-emitting element with an optical transmission member.

### Advantageous Effects of Invention

The optical receptacle of an embodiment of the present invention can attenuate light emitted from the light-emitting element while reducing generation of stray light travelling toward the light-emitting element side.

### BRIEF DESCRIPTION OF DRAWINGS

FIG. 1 is a sectional view of an optical module according to Embodiment 1 of the present invention;

FIGS. 2A and 2B are perspective views of an optical receptacle according to Embodiment 1 of the present invention;

FIGS. 3A to 3D are drawings illustrating a configuration of the optical receptacle according to Embodiment 1 of the present invention;

FIGS. 4A and 4B are sectional views of the optical receptacle according to Embodiment 1 of the present invention;

FIGS. 5A and 5B are drawings illustrating a reflection transmission part;

FIGS. 6A to 6C are graphs showing simulation results of variations of the coupling efficiency;

FIGS. 7A to 7C are drawings illustrating optical paths of the optical receptacle according to Embodiment 1;

FIGS. 8A and 8B are drawings illustrating a light blocking part;

FIGS. 9A and 9B are perspective views of an optical receptacle according to Embodiment 2;

FIGS. 10A to 10D are drawings illustrating a configuration of the optical receptacle according to Embodiment 2;

FIGS. 11A and 11B are sectional views of the optical receptacle according to Embodiment 2; and

FIGS. 12A to 12C are drawings illustrating optical paths of the optical receptacle according to Embodiment 2.

### DESCRIPTION OF EMBODIMENTS

An optical receptacle and an optical module according to the embodiment of the present invention are elaborated below with reference to the accompanying drawings.

### Embodiment 1

### Configuration of Optical Module

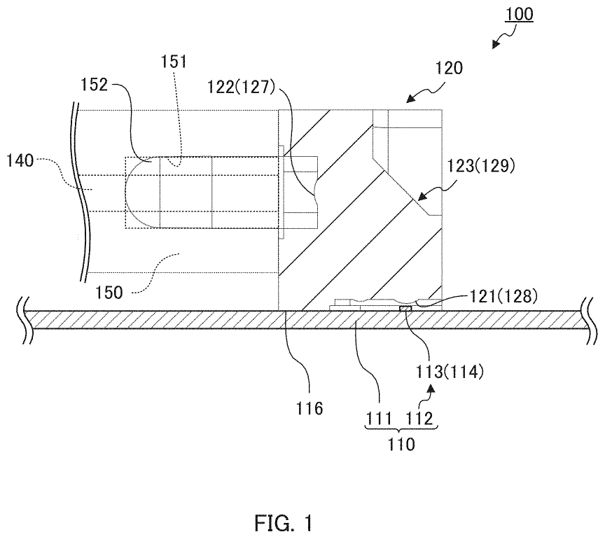

FIG. 1 is a sectional view of optical module 100 according to Embodiment 1 of the present invention.

As illustrated in FIG. 1, optical module 100 includes photoelectric conversion device 110 and optical receptacle 120. Optical module 100 is used in the state where optical transmission member 140 is connected to optical receptacle 120.

Photoelectric conversion device 110 includes substrate 111 and photoelectric conversion element 112. Photoelectric conversion element 112 and optical receptacle 120 are disposed on substrate 111. A substrate protrusion (omitted in the drawing) corresponding to a substrate recess (omitted in the drawing) of optical receptacle 120 may be formed in substrate 111. Optical receptacle 120 can be disposed at a predetermined position with respect to photoelectric conversion element 112 on substrate 111 by fitting the substrate recess to the substrate protrusion. In the present embodiment, the surface of substrate 111 is disposed such that the surface is parallel to installation surface 116 of optical receptacle 120. The material of substrate 111 is not limited. Examples of substrate 111 include a glass composite substrate and a glass epoxy substrate.

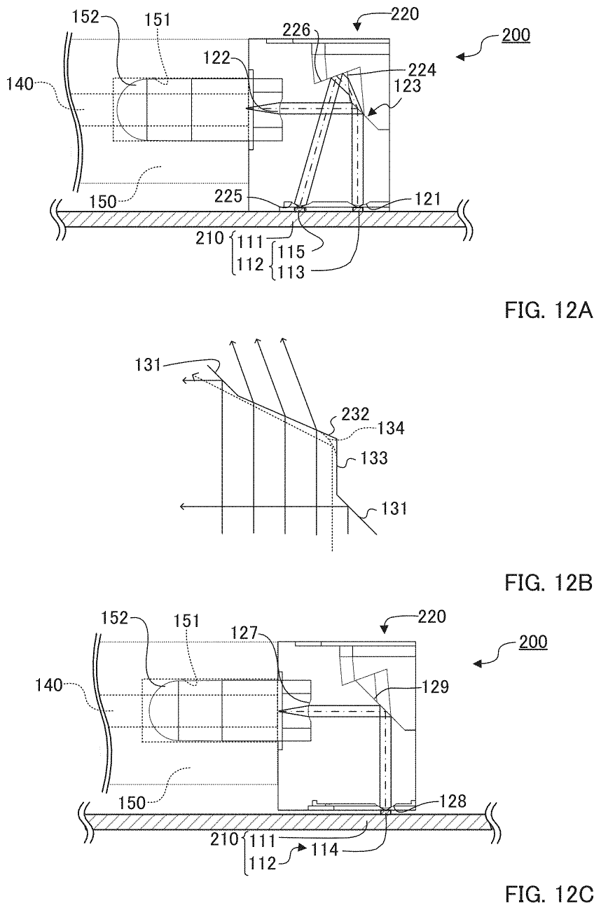

Photoelectric conversion element 112 is light-emitting element 113, light reception element 114 or detection element 115 (see FIG. 12), and is disposed on substrate 111. In the case where optical module 100 is an optical module for transmission, photoelectric conversion element 112 is light-emitting element 113. In the case where optical module 100 is an optical module for transmission and it is necessary to confirm whether light is appropriately emitted by light-emitting element 113, photoelectric conversion element 112 is light-emitting element 113 and detection element 115. In the case where optical module 100 is an optical module for reception, photoelectric conversion element 112 is light reception element 114. In the case where optical module 100 is an optical module for transmission and reception and it is necessary to confirm whether light is appropriately emitted by light-emitting element 113, photoelectric conversion element 112 is light-emitting element 113, detection element 115 and light reception element 114. Since optical module 100 according to the present embodiment is an optical module for transmission and reception that does not require the confirmation whether light is appropriately emitted by light-emitting element 113, and conversion device 110 includes, as photoelectric conversion element 112, four light-emitting elements 113 and four light reception elements 114. Light-emitting element 113 is, for example, a vertical cavity surface emitting laser (VCSEL). Light reception element 114 is, for example, a photodetector. In the present embodiment, the light-emitting surface of light-emitting element 113 and the light reception surface of light reception element 114 are parallel to each other.

Optical receptacle 120 is disposed on substrate 111 such that optical receptacle 120 faces photoelectric conversion element 112. When disposed between photoelectric conversion element 112 and optical transmission member 140, optical receptacle 120 optically couples photoelectric conversion element 112 (light-emitting element 113 or light reception element 114) and the end surface of optical transmission member 140. In optical module 100 for transmission and reception that does not require the confirmation whether light is appropriately emitted by light-emitting element 113 as in the present embodiment, optical receptacle 120 allows incidence of light emitted from light-emitting element 113 serving as photoelectric conversion element 112. Optical receptacle 120 emits a part of the incident light toward the end surface of optical transmission member 140. In addition, it allows incidence of light emitted from the end surface of optical transmission member 140, and emits the light toward the light reception surface of light reception element 114 serving as photoelectric conversion element 112.

The type of optical transmission member 140 is not limited. Examples of the type of optical transmission member 140 include an optical fiber and a light waveguide. Optical transmission member 140 is connected to optical receptacle 120 through ferrule 150. Ferrule recess 151 corresponding to ferrule protrusion 152 described later of optical receptacle 120 is formed in ferrule 150. By fitting ferrule recess 151 to ferrule protrusion 152, the end surface of optical transmission member 140 can be fixed at a predetermined position with respect to optical receptacle 120. In the present embodiment, optical transmission member 140 is an optical fiber. In addition, the optical fiber may be of a single mode type, or a multiple mode type.

### Configuration of Optical Receptacle

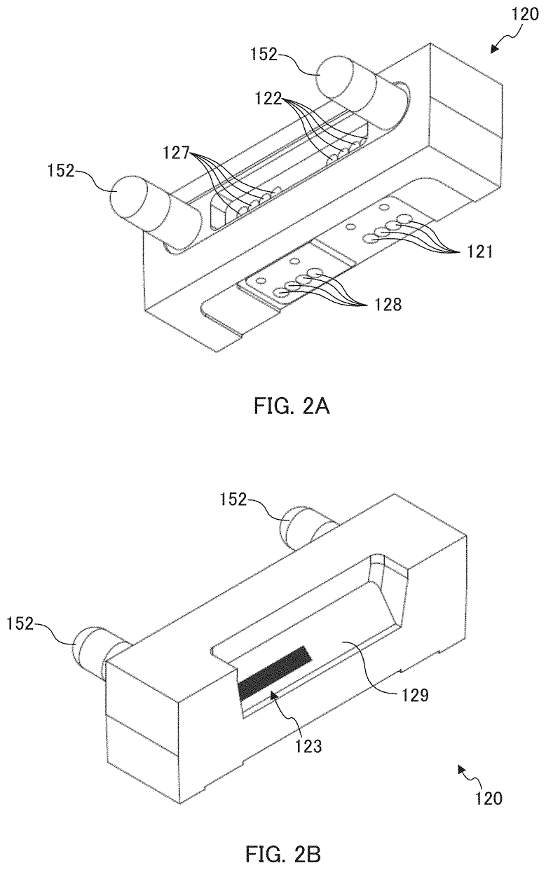

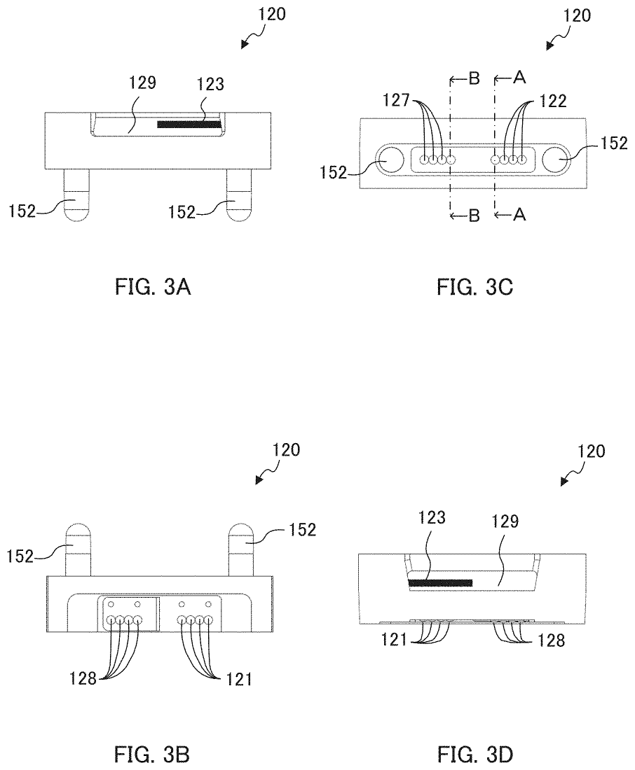

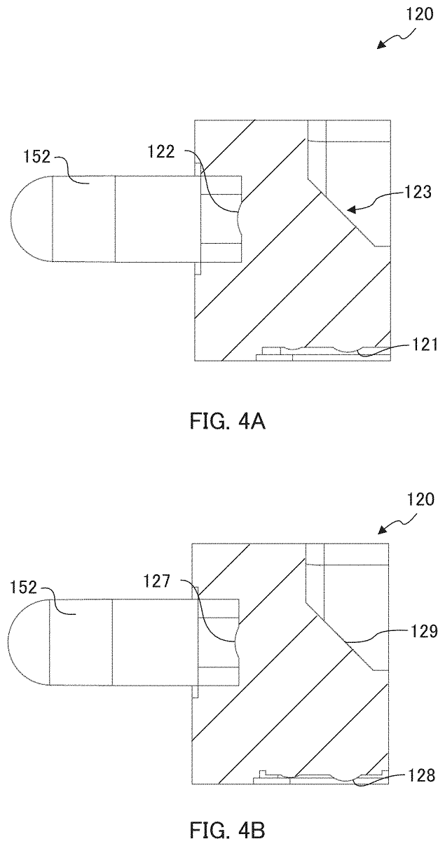

FIGS. 2A to 4B are drawings illustrating a configuration of optical receptacle 120. FIG. 2A is a perspective view of optical receptacle 120 as viewed from the bottom surface side, and FIG. 2B is a perspective view of optical receptacle 120 as viewed from the top surface side. FIG. 3A is a plan view of optical receptacle 120, FIG. 3B is a bottom view, FIG. 3C is a front view, and FIG. 3D is a back view. FIG. 4A is a sectional view taken along line A-A of FIG. 3C, and FIG. 4B is a sectional view taken along line B-B of FIG. 3C.

As illustrated in FIGS. 2A to 4B, optical receptacle 120 is a member having a substantially cuboid shape. Optical receptacle 120 includes first incidence surface 121, first emission surface 122, reflection transmission part 123, third incidence surface 127, third emission surface 128, and third reflection surface 129. First incidence surface 121, first emission surface 122 and reflection transmission part 123 are used for transmission, and third incidence surface 127, third emission surface 128 and third reflection surface 129 are used for reception.

Optical receptacle 120 is formed with a material that is optically transparent to light of wavelengths used for optical communications. Examples of the material of optical receptacle 120 include polyetherimide (PEI) such as ULTEM (registered trademark) and transparent resins such as cyclic olefin resins. In addition, optical receptacle 120 integrally produced as a single piece by injection molding, for example.

First incidence surface 121 is an optical surface for entering, into optical receptacle 120, light emitted from light-emitting element 113. First incidence surfaces 121 are disposed in a surface (bottom surface) of optical receptacle 120 that faces substrate 111 such that first incidence surfaces 121 can face respective light-emitting elements 113. The number of first incidence surfaces 121 is the same as the number of light-emitting elements 113. Specifically, in the present embodiment, four first incidence surfaces 121 are disposed on the same straight line.

The shape of first incidence surface 121 is not limited. In the present embodiment, the shape of first incidence surface 121 is a convex lens surface protruding toward light-emitting element 113. In addition, the shape of first incidence surface 121 in plan view is a circular shape. The central axis of first incidence surface 121 may be perpendicular to the light-emitting surface of light-emitting element 113 or may not be perpendicular to the light-emitting surface of light-emitting element 113. In the present embodiment, the central axis of first incidence surface 121 is perpendicular to the light-emitting surface of light-emitting element 113. In addition, the central axis of first incidence surface 121 may coincide with the optical axis of light emitted from light-emitting element 113 (the central axis of the light-emitting surface of light-emitting element 113), or may not coincide with the optical axis of light emitted from light-emitting element 113. In the present embodiment, the central axis of first incidence surface 121 coincides with the optical axis of light emitted from light-emitting element 113 (the central axis of the light-emitting surface of light-emitting element 113).

First emission surface 122 is an optical surface that emits, toward the end surface of optical transmission member 140, light entered from first incidence surface 121 and travelled inside optical receptacle 120. First emission surface 122 is disposed in the front surface of optical receptacle 120 such that first emission surface 122 can face the end surface of optical transmission member 140. The number of first emission surfaces 122 is the same as the number of first incidence surface 121. Specifically, in the present embodiment, four first emission surfaces 122 are provided. First emission surfaces 122 are disposed on the same straight line that is parallel to the direction in which first incidence surfaces 121 are disposed.

The shape of first emission surface 122 is not limited. In the present embodiment, the shape of first emission surface 122 is a convex lens surface protruding toward the end surface of optical transmission member 140. In addition, the shape of first emission surface 122 in plan view is a circular shape. The central axis of first emission surface 122 may be perpendicular to the end surface of optical transmission member 140 or may not be perpendicular to the end surface of optical transmission member 140. In the present embodiment, the central axis of first emission surface 122 is perpendicular to the end surface of optical transmission member 140. In addition, the central axis of first emission surface 122 may coincide with the central axis of the end surface of optical transmission member 140 on which the emitted light impinges, or may not coincide with the central axis of the end surface of optical transmission member 140 on which the emitted light impinges. In the present embodiment, the central axis of first emission surface 122 coincides with the central axis of the end surface of optical transmission member 140 on which the emitted light impinges.

A pair of ferrule protrusions 152 is disposed in such a manner as to sandwich the plurality of first emission surfaces 122 and a plurality of third incidence surfaces 127 described later. Ferrule protrusion 152 is fit to ferrule recess 151 formed in ferrule 150 of optical transmission member 140 as described above. Together with ferrule recess 151, ferrule protrusion 152 fixes the end surface of optical transmission member 140 at an appropriate position with respect to first emission surface 122. The shape and the size of ferrule protrusion 152 are not limited as long as the above-described effects can be achieved. In the present embodiment, ferrule protrusion 152 is a protrusion having a substantially columnar shape.

Reflection transmission part 123 reflects, toward first emission surface 122, a part of the light emitted from light-emitting element 113 and entered from first incidence surface 121, and transmits (emits) another part of the light so as to attenuate the signal light. It suffices that reflection transmission part 123 is formed at a position where the light entered from first incidence surface 121 reaches.

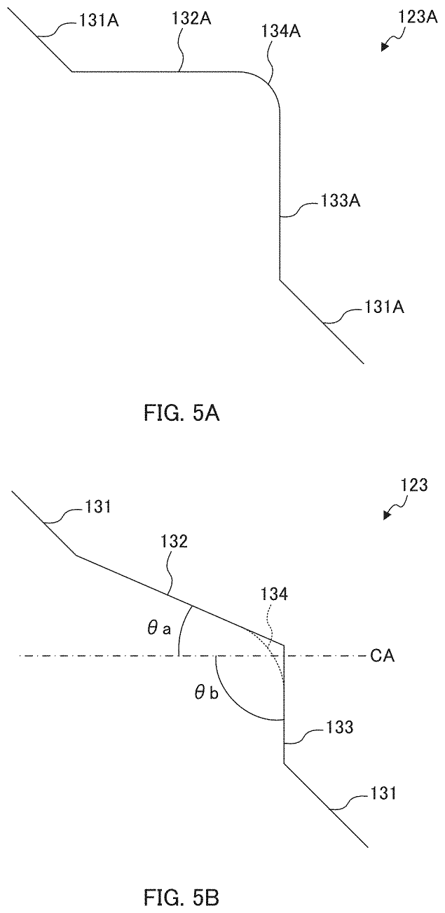

Reflection transmission part 123 includes individual reflection surface 131, individual transmission surface 132, and individual connection surface 133 (see FIG. 5). The number of individual reflection surface 131, individual transmission surface 132, and individual connection surface 133 is not limited. In the present embodiment, a plurality of individual reflection surfaces 131, a plurality of individual transmission surfaces 132, and a plurality of individual connection surfaces 133 are provided. Preferably, four or more individual reflection surfaces 131, four or more individual transmission surfaces 132, and four or more individual connection surfaces 133 are provided. In addition, in the present embodiment, individual reflection surface 131, individual transmission surface 132 and individual connection surface 133 are alternately disposed in the named order in the inclination direction of individual reflection surface 131.

Individual reflection surface 131 is an optical surface that reflects, toward first emission surface 122, a part of the light entered from first incidence surface 121. Individual reflection surface 131 may be a flat surface or a curved surface. In the present embodiment, individual reflection surface 131 is a flat surface. Individual reflection surface 131 is tilted such that it comes closer to optical transmission member 140 (first emission surface 122) in the direction from the bottom surface toward the top surface of optical receptacle 120. In the present embodiment, the inclination angle of individual reflection surface 131 is 45° with respect to the optical axis of light incident on individual reflection surface 131.

Individual transmission surface 132 is an optical surface that transmits another part of the light entered from first incidence surface 121. Individual transmission surface 132 may be a flat surface or a curved surface. In the present embodiment, individual transmission surface 132 is a flat surface. In addition, in the present embodiment, individual transmission surface 132 is tilted such that it comes closer to optical transmission member 140 (first emission surface 122) in the direction from the bottom surface toward the top surface of optical receptacle 120. Note that the inclination angle of individual transmission surface 132 with respect to first emission surface 122 is greater than the inclination angle of individual reflection surface 131 with respect to first emission surface 122.

The area ratio between individual reflection surface 131 and individual transmission surface 132 is appropriately set in accordance with the quantity of the light to be attenuated. More specifically, by adjusting the area ratio between individual reflection surface 131 and individual transmission surface 132 in side view of first incidence surface 121, the light quantity ratio between the light reflected at individual reflection surface 131 and the light transmitted through individual transmission surface 132 is adjusted.

Individual connection surface 133 is a surface that connects individual reflection surface 131 and individual transmission surface 132. Individual connection surface 133 may be a flat surface or a curved surface. In the present embodiment, individual connection surface 133 is a flat surface.

The inclination angles of individual transmission surface 132 and individual connection surface 133 will be described later.

Third incidence surface 127 is an optical surface for entering, into optical receptacle 120, the light emitted from optical transmission member 140. Third incidence surfaces 127 are disposed at the front surface of optical receptacle 120 in such a manner as to face respective optical transmission members 140. The number of third incidence surfaces 127 is the same as the number of optical transmission members 140. Specifically, in the present embodiment, four third incidence surfaces 127 are provided. Third incidence surfaces 127 are disposed in the same direction as first emission surfaces 122. In addition, in the present embodiment, first emission surfaces 122 and third incidence surfaces 127 are disposed on the same straight line.

The shape of third incidence surface 127 is not limited. In the present embodiment, the shape of third incidence surface 127 is a convex lens surface protruding toward the end surface of optical transmission member 140. In addition, the shape of third incidence surface 127 in plan view is a circular shape. The central axis of third incidence surface 127 may be perpendicular to the end surface of optical transmission member 140, or may not be perpendicular to the end surface of optical transmission member 140. In the present embodiment, the central axis of third incidence surface 127 is perpendicular to the end surface of optical transmission member 140. In addition, the central axis of third incidence surface 127 may coincide with the optical axis of the light emitted from the end surface of optical transmission member 140, or may not coincide with the optical axis of the light emitted from the end surface of optical transmission member 140. In the present embodiment, the central axis of third incidence surface 127 coincides with the optical axis of the light emitted from the end surface of optical transmission member 140.

Third emission surface 128 is an optical surface for emitting, toward light reception element 114, the light entered from third incidence surface 127 and travelled inside optical receptacle 120. Third emission surfaces 128 are disposed in a surface (bottom surface) of optical receptacle 120 that faces substrate 111, in such a manner as to face respective light reception elements 114. The number of third emission surfaces 128 is not limited. In the present embodiment, four third emission surfaces 128 are provided. Four third emission surfaces 128 are disposed in the same direction as first incidence surface 121. In addition, in the present embodiment, third emission surface 128 and first incidence surface 121 are disposed on the same straight line.

The shape of third emission surface 128 is not limited. In the present embodiment, the shape of third emission surface 128 is a convex lens surface protruding toward light reception element 114. In addition, the shape of third emission surface 128 in plan view is a circular shape. The central axis of third emission surface 128 may be perpendicular to the light reception surface of light reception element 114, or may not be perpendicular to the light reception surface of light reception element 114. In the present embodiment, the central axis of third emission surface 128 is perpendicular to the light reception surface of light reception element 114. In addition, the central axis of third emission surface 128 may coincide with the central axis of the light reception surface of light reception element 114, or may not coincide with the central axis of the light reception surface of light reception element 114. In the present embodiment, the central axis of third emission surface 128 coincides with the central axis of the light reception surface of light reception element 114.

Third reflection surface 129 is an optical surface for emitting, toward third emission surface 128, the light entered from third incidence surface 127. Third reflection surface 129 may be a flat surface or a curved surface. In the present embodiment, third reflection surface 129 is a flat surface. Third reflection surface 129 is tilted such that it comes closer to optical transmission member 140 (first emission surface 122) in the direction from the bottom surface toward the top surface of optical receptacle 120. The inclination angle of third reflection surface 129 is not limited. In the present embodiment, the inclination angle of third reflection surface 129 is 45° with respect to the optical axis of the light incident on third reflection surface 129.

Here, a relationship between individual transmission surface 132 and individual connection surface 133 is described. FIGS. 5A and 5B are diagrams illustrating a relationship between individual transmission surface 132 and individual connection surface 133. FIG. 5A is a partially enlarged sectional view of reflection transmission part 123A in an optical receptacle according to a comparative example, and FIG. 5B is a partially enlarged sectional view of reflection transmission part 123 in optical receptacle 120 according to the present embodiment. Note that hatching is omitted in FIGS. 5A and 5B.

As illustrated in FIG. 5A, it is assumed that in the optical receptacle according to the comparative example, individual transmission surface 132A is disposed such that it is parallel to installation surface 116 of the optical receptacle to substrate 111 (such that it is perpendicular to the central axis of first incidence surface 121). In addition, it is assumed that individual connection surface 133A is parallel to the central axis of first incidence surface 121 (such that it is perpendicular to central axis CA of first emission surface 122). In addition, it is assumed that in the optical receptacle according to the comparative example, individual transmission surface 132A and individual connection surface 133A may not be formed in a desired shape, and may have defective molded portion (defect) 134A.

The light entered from first incidence surface 121 reaches reflection transmission part 123A. More specifically, a part of the light entered from first incidence surface 121 reaches individual reflection surface 131A so as to be reflected toward at first emission surface 122. Another part of the light reaches individual transmission surface 132A so as to be emitted to the outside of optical receptacle 120. Note that a part of the light having reached individual transmission surface 132A may possibly be internally reflected at individual transmission surface 132A to impinge on light-emitting element 113. If the light impinges on light-emitting element 113, the intensity distribution of the emitted light may be disturbed. In addition, another part of the light reaches defective molded portion 134A. The light having reached defective molded portion 134A is reflected to the bottom surface side (light-emitting element 113 side) of optical receptacle 120. Especially the light reflected to the bottom surface side of optical receptacle 120 may become stray light and impinge on light-emitting element 113.

As illustrated in FIG. 5B, in optical receptacle 120 according to the present embodiment, individual transmission surface 132 and individual connection surface 133 satisfy the following Equation (1) to Equation (3) where θa represents the angle between individual transmission surface 132 and installation surface 116 of optical receptacle 120 to substrate 111, and θb represents the angle between individual connection surface 133 and installation surface 116 of optical receptacle 120 to substrate 111. Note that installation surface 116 is disposed such that it is parallel to the light-emitting surface of light-emitting element 113.

0°<θa<37° Equation (1)

70°<θb≤90° Equation (2)

θa+θb≥100° Equation (3)

As expressed in Equation (1), θa is greater than 0°, and smaller than 37°. In the case where θa is greater than 0°, the stray light travelling toward the bottom surface side can be reduced since the light travels toward the top surface side of optical receptacle 120 even when light reaches molding defect 134. In the case where θa is 0°, a part of the light entered from first incidence surface 121 and having directly reached individual transmission surface 132 may be internally reflected to re-enter light-emitting element 113. On the other hand, in the case where θa is 37° or greater, the light entered from first incidence surface 121 and having directly reached individual transmission surface 132 may not be transmitted therethrough. As expressed in Equation (2), θb is greater than 70°, and 90° or smaller. It is preferable that the upper limit of θb be smaller than 90°. In addition, it is preferable that the lower limit value of θb be 85° or greater, more preferably 87° or greater. In other words, it is preferable that the line of intersection of individual transmission surface 132 and individual connection surface 133 be disposed in a position at a dead angle with respect to light emitted from light-emitting element 113 and entered from first incidence surface 121. In the case where θb falls within the range of Equation (2), the light entered from first incidence surface 121 is not attenuated more than necessary. In addition, in the case where θb is equal to or greater than 85° and smaller than 90°, the light emitted from light-emitting element 113 and entered from first incidence surface 121 does not reach the region in the vicinity of the line of intersection, and thus generation of the stray light can be further suppressed. Further, in the case where θb is equal to or greater than 87° and smaller than 90°, the angle of diagonal punching during injection molding is smaller, which facilitates production. In addition, the light transmitted through individual transmission surface 132 less likely to impinge on individual connection surface 133.

As expressed in Equation (3), θa+θb is 100° or greater. In the case where θa+θb is smaller than 100°, the molding performance is low, and the molding defect may be caused.

Here, variations of the coupling efficiency between light-emitting element 113 and optical transmission member 140 were simulated by moving optical receptacle 120 according to the present embodiment and the optical receptacle according to the comparative example in the X direction, the Y direction and the Z direction with respect to optical transmission member 140 from the position where the maximum coupling efficiency is obtained. Here, “X direction” means a direction in which light-emitting element 113 and light reception element 114 are disposed (the depth direction in FIG. 1), the “Y direction” means a direction orthogonal to a line parallel to the X direction in a plane parallel to the surface of substrate 111, and the “Z direction” means a direction perpendicular to the X direction and the Y direction.

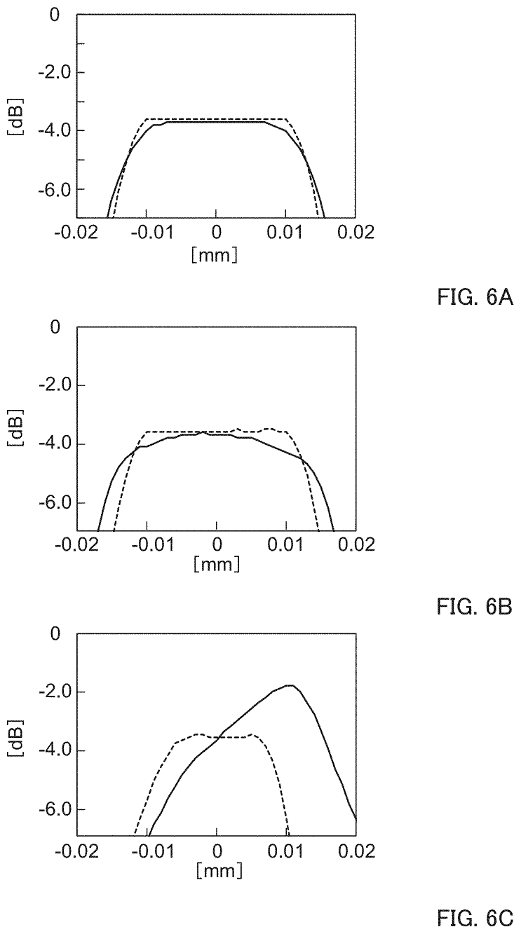

FIGS. 6A to 6C are graphs showing simulation results of variations of the coupling efficiency. FIG. 6A shows a simulation result of a case where the optical receptacle is moved in the X direction, FIG. 6B shows a simulation result of a case where the optical receptacle is moved in the Y direction, and FIG. 6C shows a simulation result of a case where the optical receptacle is moved in the ZX direction. In FIGS. 6A to 6C, the abscissa indicates the movement amount of the optical receptacle, and the ordinate indicates the maximum coupling efficiency. In FIGS. 6A to 6C, the solid line indicates results of optical receptacle 120 according to the present embodiment, and the dotted line indicates results of the optical receptacle according to the comparative example.

Note that the optical receptacle according to the comparative example includes two individual reflection surfaces 131B, two individual transmission surfaces 132B and two individual connection surfaces 133B, and optical receptacle 120 according to the present embodiment includes five individual reflection surfaces 131, five individual transmission surfaces 132 and five individual connection surfaces 133. In addition, in optical receptacle 120 of the present embodiment, θa is 35° and θb is 90°.

As illustrated in FIGS. 6A to 6C, in comparison with the optical receptacle according to the comparative example, optical receptacle 120 according to the present embodiment suppresses the reduction of the coupling efficiency even when the positions of optical transmission member 140 and optical receptacle 120 are shifted. More specifically, when the positional displacement width between optical receptacle 120 and optical transmission member 140 that causes a reduction of a coupling efficiency of 0.50 dB or smaller is defined as “tolerance width”, the optical receptacle according to the comparative example had a tolerance width of 20 μm when moved in the X direction, a tolerance width of 19 μm when moved in the Y direction, and a tolerance width of 40 μm when moved in the Z direction. On the other hand, optical receptacle 120 according to the present embodiment had a tolerance width of 22 μm when moved in the X direction, a tolerance width of 22 μm when moved in the Y direction, and a tolerance width of 130 μm when moved in the Z direction.

Note that the amount of the light emitted from light-emitting element 113 to reach optical transmission member 140 is determined by the area ratio between individual reflection surface 131 and individual transmission surface 132, and therefore it is conceivable that optical receptacle 120 according to the present embodiment can increase the tolerance width by increasing the number of individual reflection surfaces 131 and individual transmission surfaces 132 in comparison with the optical receptacle according to the comparative example.

### Optical Path in Optical Module

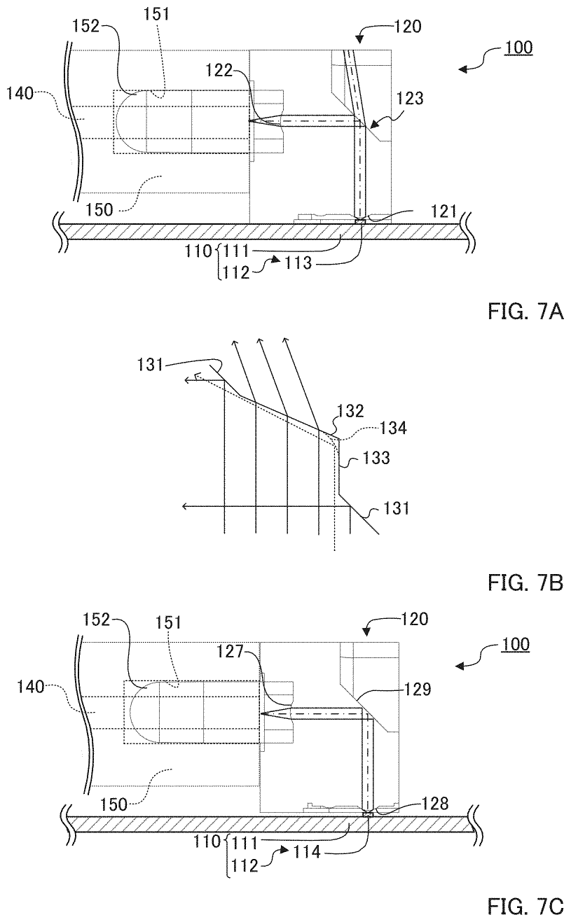

Now, optical paths in optical module 100 according to the present embodiment are described. FIGS. 7A to 7C are drawings illustrating optical paths in optical module 100. FIG. 7A illustrates optical paths in a cross-section of a transmission side portion illustrated in FIG. 4A, FIG. 7B illustrates optical paths in a partially enlarged cross-section of reflection transmission part 123, and FIG. 7C illustrates optical paths in a cross-section of a reception side portion illustrated in FIG. 4B.

As illustrated in FIGS. 7A and 7B, the light emitted from light-emitting element 113 enters optical receptacle 120 from first incidence surface 121. The light entered from first incidence surface 121 advances toward reflection transmission part 123 and reaches reflection transmission part 123. Since reflection transmission part 123 includes individual reflection surface 131, individual transmission surface 132 and individual connection surface 133, a part of the light having reached reflection transmission part 123 is reflected at individual reflection surface 131 toward first emission surface 122, and another part of the light is transmitted through individual transmission surface 132. At this time, light emitted from individual transmission surface 132 is refracted toward first emission surface 122 side since individual transmission surface 132 is tilted such that it comes closer to first emission surface 122 in the direction from the bottom surface toward the top surface of optical receptacle 120. In addition, even in the case where the defective molded portion 134 is formed, the light entered from first incidence surface 121 is reflected toward the top surface of optical receptacle 120 (see the dotted line of FIG. 7B).

The light reflected by reflection transmission part 123 (individual reflection surface 131) reaches first emission surface 122. The light having reached first emission surface 122 is emitted at first emission surface 122 toward the end surface of optical transmission member 140.

The light transmitted through the reflection transmission part (individual transmission surface 132) advances toward light first emission surface 122 side, and therefore does not become stray light.

In this manner, the light entered from first incidence surface 121 advances toward optical transmission member 140 while being attenuated by the amount corresponding to its transmission through individual transmission surface 132.

As illustrated in FIG. 7C, the light emitted from optical transmission member 140 enters optical receptacle 120 from third incidence surface 127. The light entered optical receptacle 120 advances toward third reflection surface 129 and reaches third reflection surface 129. The light having reached third reflection surface 129 is internally reflected toward third emission surface 128. The light having reached third emission surface 128 is emitted toward light reception element 114.

### Effect

As described above, in optical receptacle 120 according to the present embodiment, individual transmission surface 132 and individual connection surface 133 are disposed to satisfy 0°<θa<37°, 70°<θb≤90° and θa+θb≥100°, and thus the light emitted from the light-emitting element can be attenuated while reducing the generation of the stray light travelling toward the light-emitting element 113 side.

Note that while optical module 100 for transmission and reception is described in the present embodiment, it is also possible to adopt an optical module for transmission. In this case, the optical receptacle does not include third incidence surface 127, third emission surface 128 and third reflection surface 129.

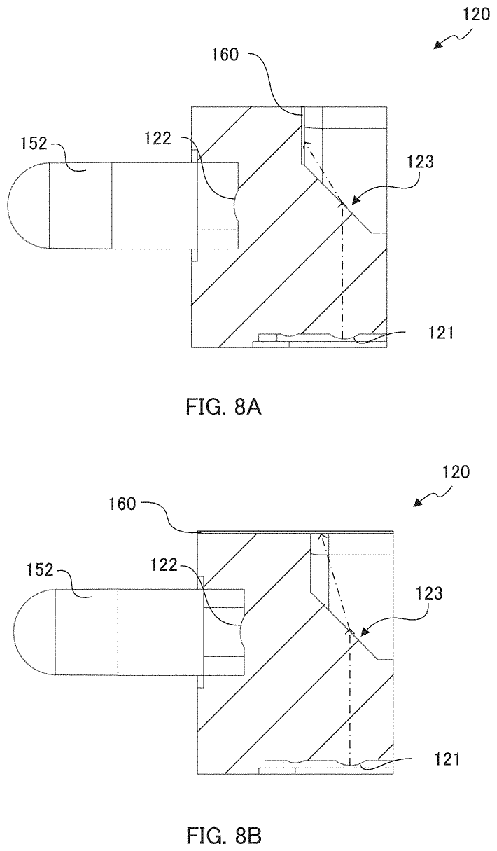

Note that optical receptacle 120 according to Embodiment 1 may include light blocking part 160 for blocking light emitted from individual transmission surface 132. FIGS. 8A and 8B are drawings illustrating light blocking part 160.

As illustrated in FIG. 8A, in the case where light emitted from individual transmission surface 132 reaches optical receptacle 120 again, light blocking part 160 may be disposed in the region where the light reaches. In this case, light blocking part 160 is, for example, a light absorption film that absorbs light or a grain surface formed in that region.

As illustrated in FIG. 8B, in the case where light emitted from individual transmission surface 132 does not reach optical receptacle 120 again, light blocking part 160 may be formed in the region where the light reaches optical receptacle 120. In this case, the light blocking part is, for example, a cover or a film for protecting reflection transmission part 123. In this case, it is preferable that light blocking part 160 be composed of a material that absorbs light emitted from individual transmission surface 132.

### Embodiment 2

### Configuration of Optical Module

Optical module 200 according to Embodiment 2 is configured to detect detection light for detecting whether light is appropriately emitted from light-emitting element 113. Optical module 200 according to the present embodiment is different from optical module 100 according to Embodiment 1 in the configuration of optical receptacle 220. As such, the same configurations as those of optical module 100 according to Embodiment 1 are denoted with the same reference numerals, and the description thereof is omitted, and, features are described below.

Optical module 200 according to Embodiment 2 includes photoelectric conversion device 210 and optical receptacle 220 (see FIG. 12).

Photoelectric conversion device 210 according to the present embodiment includes substrate 111 and photoelectric conversion element 112. In the present embodiment, optical module 100 is optical module 100 for transmission and reception and it is necessary to confirm whether light is appropriately emitted by light-emitting element 113. As such, photoelectric conversion element 112 is light-emitting element 113, detection element 115 and light reception element 114. Detection element 115 is, for example, a photodetector. The number of detection elements 115 is the same as the number of light-emitting elements 113. In the present embodiment, four detection elements 115 are provided since four light-emitting elements 113 are disposed. In addition, four detection elements 115 are arranged on a straight line that is parallel to the arrangement direction of four light-emitting elements 113.

### Configuration of Optical Receptacle

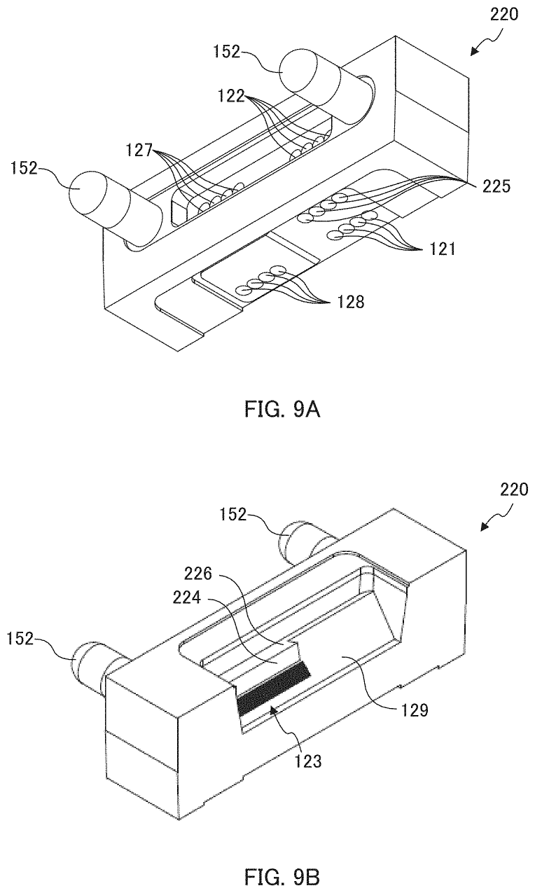

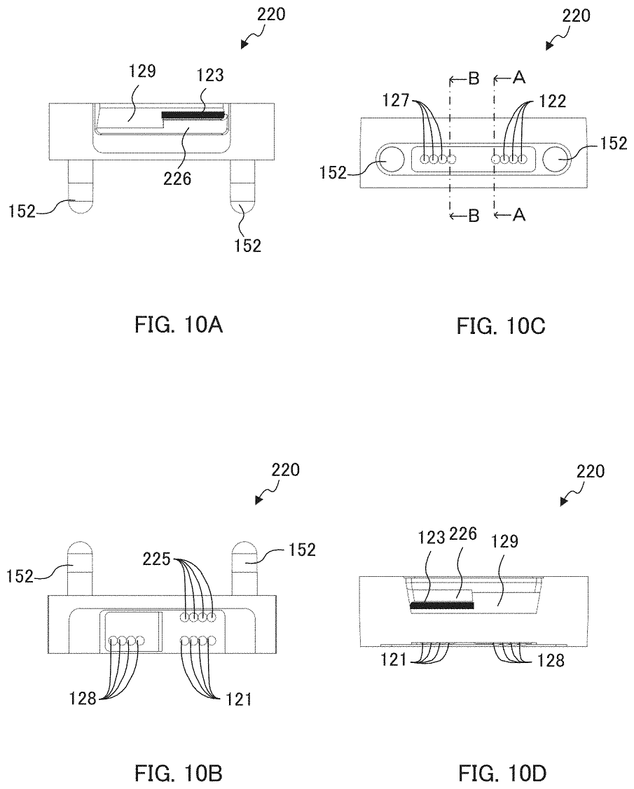

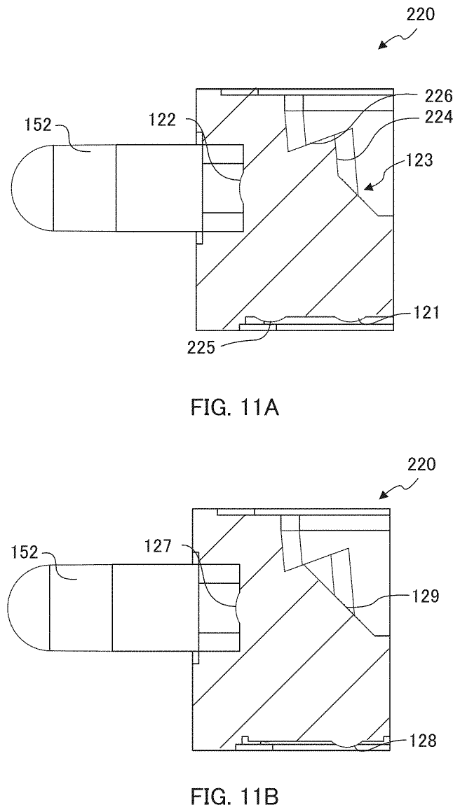

FIGS. 9A to 11B are drawings illustrating a configuration of optical receptacle 220. FIG. 9A is a perspective view of optical receptacle 220 as viewed from the bottom surface side, and FIG. 9B is a perspective view of optical receptacle 220 as viewed from the top surface side. FIG. 10A is a plan view of optical receptacle 120, FIG. 10B is a bottom view, FIG. 10C is a front view, and FIG. 10D is a back view. FIG. 11A is a sectional view taken along line A-A of FIG. 10C, and FIG. 11B is a sectional view taken along line B-B of FIG. 10C.

Optical receptacle 220 includes first incidence surface 121, first emission surface 122, reflection transmission part 123, second incidence surface 224, second emission surface 225, second reflection surface 226, third incidence surface 127, third emission surface 128, and third reflection surface 129. The material of optical receptacle 220 of the present embodiment is the same as the material of optical receptacle 120 of Embodiment 1. In addition, in the present embodiment, at least first incidence surface 121, first emission surface 122, reflection transmission part 123, second incidence surface 224, second emission surface 225 and second reflection surface 226 are integrally molded as a single piece.

Second incidence surface 224 is an optical surface for reentering, into optical receptacle 220, at least a part of light transmitted (emitted) through individual transmission surface 132 of reflection transmission part 123. Preferably, second incidence surface 224 is disposed on first emission surface 122 side than reflection transmission part 123. The shape of second incidence surface 224 is not limited as long as the above-mentioned function can be ensured. In the present embodiment, the shape of second incidence surface 224 is a flat surface.

Second emission surface 225 is an optical surface for emitting, toward detection element 115, light that has advanced inside optical receptacle 220. Second emission surfaces 225 are disposed in a surface (bottom surface) of optical receptacle 220 that faces substrate 111, in such a manner as to face respective detection elements 115. The number of second emission surfaces 225 is not limited. In the present embodiment, four second emission surfaces 225 are provided. Second emission surface 225 are arranged on a straight line that is parallel to first incidence surface 121 and third emission surface 128.

The shape of second emission surface 225 is not limited. In the present embodiment, the shape of second emission surface 225 is a convex lens surface protruding toward detection element 115. In addition, the shape of second emission surface 225 in plan view is a circular shape. The central axis of second emission surface 225 may be perpendicular to the light reception surface of detection element 115, or may not be perpendicular to the light reception surface of detection element 115. In the present embodiment, the central axis of second emission surface 225 is perpendicular to the light reception surface of detection element 115. In addition, the central axis of second emission surface 225 may coincide with the central axis of the light reception surface of detection element 115, or may not coincide with the central axis of the light reception surface of detection element 115. In the present embodiment, the central axis of second emission surface 225 coincides with the central axis of the light reception surface of detection element 115.

Second reflection surface 226 is an optical surface for internally reflecting, toward second emission surface 225, the light entered from second incidence surface 224. Second reflection surface 226 may be a flat surface or a curved surface. In the present embodiment, second reflection surface 226 is a flat surface. In the present embodiment, second reflection surface 226 is formed such that it is parallel to the surface of substrate 111 in the direction from the bottom surface toward the top surface of optical receptacle 220.

Note that also in the present embodiment, individual transmission surface 132 and individual connection surface 133 satisfy the following Equation (1) to Equation (3) where θa represents the angle between individual transmission surface 132 and installation surface 116 of optical receptacle 120 to substrate 111, and θb represents the angle between individual connection surface 133 and installation surface 116 of optical receptacle 120 to substrate 111.

0°<θa<37° Equation (1)

70°<θb≤90° Equation (2)

θa+θb≥100° Equation (3)

### Optical Path in Optical Module

Now, optical paths in optical module 200 according to the present embodiment are described. FIGS. 12A to 12C are drawings illustrating optical paths in optical module 200. FIG. 12A is a drawing illustrating optical paths in a cross-section of a transmission side portion illustrated in FIG. 11A, FIG. 12B is a drawing illustrating optical paths in a partially enlarged cross-section of reflection transmission part 123, and FIG. 12C is a drawing illustrating optical paths in a cross-section of a reception side portion illustrated in FIG. 11B.

As illustrated in FIGS. 12A and 12B, the light emitted from light-emitting element 113 enters optical receptacle 220 from first incidence surface 121. The light entered from first incidence surface 121 advances toward reflection transmission part 123 and reaches reflection transmission part 123. Since reflection transmission part 123 includes individual reflection surface 131, individual transmission surface 232 and individual connection surface 133, a part of the light having reached reflection transmission part 123 is reflected at individual reflection surface 131 toward first emission surface 122, and another part of the light is transmitted through individual transmission surface 232. At this time, since individual transmission surface 232 is tilted such that it comes closer to first emission surface 122 in the direction from the bottom surface toward the top surface of optical receptacle 220, the light emitted from individual transmission surface 232 is refracted toward first emission surface 122 side. In addition, even in the case where the defective molded portion 134 is formed, the light entered from first incidence surface 121 is reflected toward the top surface of optical receptacle 220 (see the dotted line of FIG. 12B).

The light reflected by reflection transmission part 123 (individual reflection surface 131) reaches first emission surface 122. The light having reached first emission surface 122 is emitted at first emission surface 122 toward the end surface of optical transmission member 140.

The light transmitted (emitted) through the reflection transmission part (individual transmission surface 232) advances toward second incidence surface 224. At least a part of the light having reached second incidence surface 224 reenters optical receptacle 220. The light having entered optical receptacle 220 from second incidence surface 224 advances toward second reflection surface 226. The light having reached second reflection surface 226 is internally reflected toward second emission surface 225. The light having reached second emission surface 225 is emitted toward detection element 115.

As illustrated in FIG. 12C, the light emitted from optical transmission member 140 enters optical receptacle 220 from third incidence surface 127. The light entered from third incidence surface 127 advances toward third reflection surface 129. The light having reached third reflection surface 129 is internally reflected toward third emission surface 128. The light having reached third emission surface 128 is emitted toward light reception element 114.

In this manner, the light entered from first incidence surface 121 advances toward optical transmission member 140 while being attenuated by the amount corresponding to its transmission through individual transmission surface 232.

### Effect

As described above, optical module 200 according to the present embodiment can detect whether light is appropriately emitted from light-emitting element 113, while achieving the effects of optical module 100 according to Embodiment 1.

Note that also in the present embodiment, optical module 200 may be an optical module for transmission. In this case, optical receptacle 220 does not include third incidence surface 127, third emission surface 128 and third reflection surface 129.

Note that in the present embodiment, a part of the light emitted from light-emitting element 113 is used as detection light, and therefore the light blocking part may not be provided.

### INDUSTRIAL APPLICABILITY

The optical receptacle and the optical module according to the present invention are useful for optical communications using optical transmission members.

### REFERENCE SIGNS LIST

100, 200 Optical module
110, 210 Photoelectric conversion device
111 Substrate
112 Photoelectric conversion element
113 Light-emitting element
114 Light reception element
115 Detection element
116 Installation surface
120, 220 Optical receptacle
121 First incidence surface
122 First emission surface
123 Reflection transmission part
123A Reflection transmission part
127 Third incidence surface
128 Third emission surface
129 Third reflection surface
131 Individual reflection surface
131A Individual reflection surface
132, 232 Individual transmission surface
132A Individual transmission surface
133 Individual connection surface
133A Individual connection surface
134, 134A Defective molded portion
140 Optical transmission member
150 Ferrule
151 Ferrule recess
152 Ferrule protrusion
160 Light blocking part
224 Second incidence surface
225 Second emission surface
226 Second reflection surface
CA Central axis

What is claimed is:

1. An optical receptacle configured to optically couple a light-emitting element disposed on a substrate and an optical transmission member in a state where the optical receptacle is disposed between the light-emitting element and the optical transmission member, the optical receptacle comprising:
a first incidence surface configured to allow incidence of light emitted from the light-emitting element;
a first emission surface configured to emit, toward the optical transmission member, light entered from the first incidence surface and advanced inside the optical receptacle; and
a reflection transmission part configured to reflect, toward the first emission surface, a part of the light entered from the first incidence surface, and transmit another part of the light entered from the first incidence surface,
wherein the reflection transmission part includes:
an individual reflection surface configured to reflect, toward the first emission surface, the part of the light entered from the first incidence surface,
an individual transmission surface configured to transmit the other part of the light entered from the first incidence surface, and
an individual connection surface configured to connect the individual reflection surface and the individual transmission surface, and
wherein the following Equation (1) to Equation (3) are satisfied:
0°<θa<37° Equation (1)
70°<θb≤90° Equation (2)
θa−θb≥100° Equation (3)
where θa is an angle between the individual transmission surface and an installation surface of the optical receptacle to the substrate, and θb is an angle between the individual connection surface and the installation surface.

2. The optical receptacle according to claim 1, wherein the θb is smaller than 90°.

3. The optical receptacle according to claim 1, wherein the θb is 85° or greater.

4. The optical receptacle according to claim 1, wherein a line of intersection of the individual transmission surface and the individual connection surface is disposed in a position at a dead angle with respect to light emitted from the light-emitting element and entered from the first incidence surface.

5. The optical receptacle according to claim 1, further comprising:
a second incidence surface configured to re-enter a part of light transmitted through the individual transmission surface;
a second emission surface configured to emit, toward a detection element, light entered from the second incidence surface and advanced inside the optical receptacle; and
a second reflection surface configured to reflect, toward the second emission surface, the light entered from the second incidence surface,
wherein the first incidence surface, the first emission surface, the reflection transmission part, the second incidence surface, the second reflection surface and the second emission surface are integrally molded as a single piece.

6. The optical receptacle according to claim 5, wherein the second incidence surface is disposed on a first emission surface side than the reflection transmission part.

7. The optical receptacle according to claim 1, further comprising:
a third incidence surface configured to enter light emitted from the optical transmission member;
a third emission surface configured to emit, toward the light reception element, light advanced inside the optical receptacle; and
a third reflection surface configured to reflect, toward the third emission surface, light entered from the third incidence surface.

8. An optical module, comprising:
a photoelectric conversion device including a light-emitting element; and
the optical receptacle according to claim 1 configured to optically couple light emitted from the light-emitting element with an optical transmission member.

9. An optical module, comprising:
a photoelectric conversion device including a light-emitting element and a detection element; and
the optical receptacle according to claim 5 configured to optically couple light emitted from the light-emitting element with an optical transmission member.

10. An optical module, comprising:
a photoelectric conversion device including a light-emitting element, a detection element and a light reception element; and
the optical receptacle according to claim 7 configured to optically couple light emitted from the light-emitting element with an optical transmission member and configured to optically couple light emitted from the optical transmission member with the light reception element.
